(19) United States
(12) Patent Application Publication
(10) Pub. No.: US 2025/0030249 A1
(43) Pub. Date: Jan. 23, 2025

(54) ISLANDING METER SOCKET ADAPTER TO CONNECT MULTIPLE BIDIRECTIONAL DISTRIBUTED ENERGY RESOURCES

(71) Applicant: CONNECTDER, INC., Philadelphia, PA (US)

(72) Inventors: John Schroeder, Falls Church, VA (US); Khanti Munro, Falls Church, VA (US); Whitman Fulton, Falls Church, VA (US); Christian Cote, Philadelphia, PA (US); Daniel Anthony Falcone, Willow Grove, PA (US)

(73) Assignee: CONNECTDER, INC., Philadelphia, PA (US)

(21) Appl. No.: 18/902,617

(22) Filed: Sep. 30, 2024

Related U.S. Application Data
(63) Continuation-in-part of application No. 18/830,533, filed on Sep. 10, 2024.
Application No. 18/830,533 is a continuation-in-part of application No. 17/307,426, filed on May 4, 2021.
(60) Provisional application No. 62/986,025, filed on Mar. 6, 2020.
(60) Provisional application No. 63/537,778, filed on Sep. 11, 2023.

(51) Int. Cl. H02J 3/38; H02J 9/06; H02J 13/00

(52) U.S. Cl. CPC H02J 3/388; H02J 9/068; H02J 13/00004

(57) ABSTRACT

A meter socket adapter may include an integrated whole-building disconnect switch configured to disconnect a building associated with the meter socket adapter from a utility grid, a distributed energy resource (DER) interface to connect a distributed energy resource (DER), and an energy management system (EMS) configured to monitor electrical current passing through the meter socket adapter and, based on the monitored current, actuate the whole-building disconnect switch.

### CROSS-REFERENCE TO RELATED APPLICATIONS

This application is a Continuation-In-Part of U.S. Non-provisional application Ser. No. 18/830,533, filed Sep. 10, 2024 which is a Continuation-In-Part of U.S. Non-provisional application Ser. No. 17/307,426, filed May 4, 2021 which claims priority to U.S. Provisional Application No. 62/986,025, filed Mar. 6, 2020 and which claims priority to U.S. Provisional Application No. 63/537,778 filed Sep. 11, 2023, which applications are herein incorporated by reference in their entirety.

### TECHNICAL FIELD

The embodiments described and recited herein pertain, generally, to electrical power storage and deployment.

### BACKGROUND

Electric vehicles (EVs) utilize battery packs, which include electrical energy storage systems that provide energy to power the vehicle and its accessories. The energy storage system corresponding to some EVs may be utilized for other purposes external to the EV itself, including powering small loads from appliances, powering site-level loads, or even returning power to the utility electric grid.

More broadly, electrical energy storage, whether housed in an EV or not, is falling in cost and increasing in prevalence. It can provide grid stability, generation cost reduction, and, when installed on-site with electrical loads, can keep those loads powered during grid outages.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure relate to a meter socket adapter (MSA) including an integrated whole-building disconnect switch configured to disconnect a building associated with the MSA from a utility grid, one or more sensors configured to capture measurements of grid voltage, a communication circuit configured to transmit the measurements of grid voltage to co-located electrical equipment, receive a disconnect signal from the co-located electrical equipment, and in response to the disconnect signal, actuate the whole-building disconnect switch.

Aspects of the present disclosure relate to a meter socket adapter (MSA) system including an MSA including an integrated whole-building disconnect switch configured to disconnect a building associated with the MSA from a utility grid, a distributed energy resource (DER) interface to connect a distributed energy resource (DER) controller, and a communication circuit configured to in response to a disconnect signal from the DER controller, actuate the whole-building disconnect switch, and a housing separate from the MSA, the housing enclosing a distributed energy resource (DER) disconnect switch and a control circuit configured to monitor electrical current from the DER controller, and based on the monitored current, actuate the DER disconnect switch.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different FIGS. indicates similar or identical items.

FIG. 1 shows a schematic drawing of a power distribution system, in accordance with at least one example embodiment described and recited herein;

FIG. 2 shows a schematic drawing of a power distribution system, in accordance with at least one example embodiment described and recited herein;

FIG. 3 shows a schematic drawing of an energy storage system, in accordance with at least one example embodiment described and recited herein;

FIG. 4 shows a schematic drawings of an energy storage system, in accordance with at least one example embodiment described and recited herein;

FIG. 5 shows a schematic drawings of an electrical path corresponding at least one example embodiment of a weatherized energy storage system as described and recited herein;

FIG. 6 shows a schematic drawings of a wireless communications path corresponding at least one example embodiment of an energy storage system as described and recited herein;

FIG. 7 shows a schematic drawing of the electric vehicle charger interface, in accordance with at least one example embodiment described and recited herein;

FIG. 8 shows a single line schematic drawing of the electric vehicle charger interface, in accordance with at least one other example embodiment described and recited herein;

FIG. 9 shows a schematic drawing of a socket adaptor in accordance with at least one example embodiment described and recited herein;

FIG. 10 shows a schematic drawing of a socket adaptor in accordance with at least one other example embodiment described and recited herein;

FIG. 11 shows an operation flow, in accordance with at least one example embodiment described and recited herein;

FIG. 12A shows a schematic diagram of an override component, in accordance with at least one example embodiment described and recited herein;

FIG. 12B shows a schematic diagram of the override reset actuator of FIG. 12A, in accordance with at least one example embodiment described and recited herein;

FIG. 12C also shows a schematic diagram of the override reset actuator of FIG. 12A, in accordance with at least one example embodiment described and recited herein;

FIG. 13 shows an operational flow for implementing an override, in accordance with at least one example embodiment described and recited herein;

FIG. 14A shows a side view of an adaptor, in accordance with at least one example embodiment described and recited herein;

FIG. 14B shows a front view of an adaptor, in accordance with at least one example embodiment described and recited herein;

FIG. 14C shows a review of an adaptor, in accordance with at least one example embodiment described and recited herein;

FIG. 15A shows a top view of an adaptor interface, in accordance with at least one example embodiment described and recited herein;

FIG. 15B shows a bottom view of an adaptor interface, in accordance with at least one example embodiment described and recited herein;

FIG. 16A shows a side view of a socket adaptor, in accordance with at least one example embodiment described and recited herein;

FIG. 16B shows a planar view of a socket adaptor, in accordance with at least one example embodiment described and recited herein;

FIG. 17 shows a side view of an adaptor interface, in accordance with at least one example embodiment described and recited herein;

FIG. 18 shows a wireless adaptor interface, in accordance with at least one example embodiment described and recited herein;

FIG. 19A shows a side view of an adaptor interface, in accordance with at least one other example embodiment described and recited herein;

FIG. 19B shows components of the adaptor interface of FIG. 19A, in accordance with at least one example embodiment described and recited herein;

FIG. 20A shows a mating of a socket adaptor and adaptor interface, in accordance with at least one example embodiment described and recited herein;

FIG. 20B shows the mated socket adaptor and adaptor interface of FIG. 20A, in accordance with at least one example embodiment described and recited herein;

FIG. 21A shows a configuration of the adaptor interface, in accordance with at least one example embodiment described and recited herein;

FIG. 21B shows another configuration of the adaptor interface, in accordance with at least one example embodiment described and recited herein;

FIG. 22A shows another configuration of an adaptor interface, in accordance with at least one example embodiment described and recited herein;

FIG. 22B shows another configuration of the adaptor interface of FIG. 22A, in accordance with at least one example embodiment described and recited herein;

FIG. 23A illustrates an example system including a meter socket adapter and an additional housing including a control circuit, in accordance with at least one other example embodiment described and recited herein;

FIG. 23B illustrates an example system including a meter socket adapter, in accordance with at least one other example embodiment described and recited herein; and

FIG. 23C illustrates an example system including a meter socket adapter and an additional housing, in accordance with at least one other example embodiment described and recited herein.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to a meter socket adapter (MSA) including one or more sensors for measuring utility grid voltage, current from the utility grid, and voltage and current from one or more DERs. The MSA can provide the sensor measurements and additional information to the DERs, or a DER controller, for control of the DERs. In this way, the DERs can be controlled with a view of the entire connected electrical system, as provided by the sensors of the MSA. Thus, overcurrent conditions at the MSA or meter socket can be prevented and the DERs can be more efficiently controlled by providing the sensor measurements to the DERs or DER controller.

Furthermore, the MSA can include a whole-building disconnect, allowing for the formation of a microgrid (e.g., islanding) including the building and the DERs. The MSA may receive a disconnect signal from the DERs or DER controller to actuate the whole-building disconnect in order to isolate the building and DERs from the utility grid. In this way, the building can be provided with power even if the utility grid ceases to provide power. The MSA can monitor the utility grid such that the whole-building disconnect can be actuated to reconnect the building to the utility grid once the utility grid is once more providing power.

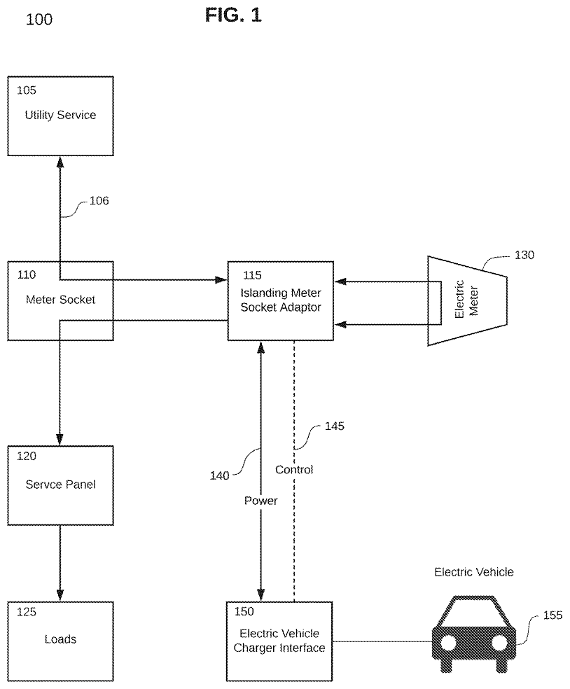

FIG. 1 shows a schematic drawing of a power distribution system, in accordance with at least one example embodiment described and recited herein. As depicted, system 100 includes, at least, utility service 105, meter socket 110, islanding meter socket adaptor 115, service panel 120, loads 125, electric meter 130, electric vehicle charger interface 150, and electric vehicle 155.

Utility service 105 may refer to a public utility distribution system that supplies two-phase power or one-phase power via a meter to a customer.

Meter socket 110 may refer to a socket having utility-side contacts to interface with utility service 105 and customer-side contacts to electrically connect to a customer's private distribution system, e.g., islanding meter socket adaptor 115 and service panel 120.

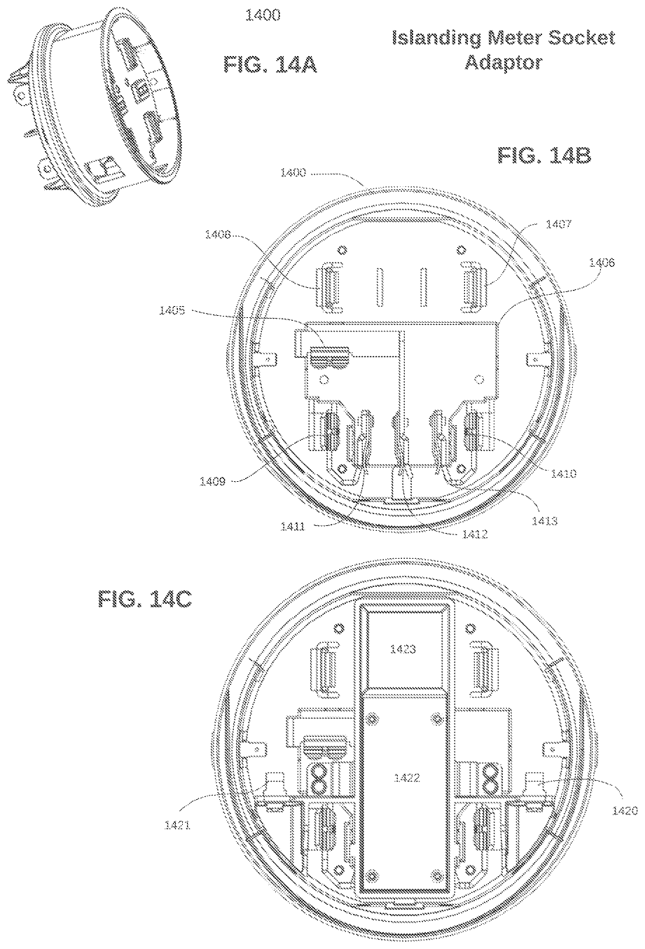

Islanding meter socket adaptor 115 may refer to a device depicted in FIG. 14A that plugs into the meter socket 110 and resides between the meter socket and electric meter 130.

Service panel 120 may refer to the main service panel that provides a distribution point for the customer's loads 125. This panel usually contains circuit protection devices and terminal points that enable the distribution of power through the private facility.

Loads 125 may refer to the typical loads found in a private facility. Some examples of typical loads include, but not limited to, electric appliances, air conditioners, electric hot water heaters, and electric outlets.

Electric meter 130 may refer to a power metering device that plugs into the Islanding meter socket adaptor 115. Electric meters are typically utilized to monitor the power consumption or production at a Utility customer's facility for the purpose of billing for the utility service.

Electric vehicle charger interface 150 may refer to a charger interface that may interact with islanding meter socket adaptor 115 to safely enable an electric vehicle 155 to connect to the load side of meter socket 110. In accordance with at least one example embodiment described and recited herein, electric vehicle charger interface 150 resides onboard electric vehicle 155 to reduce the number of external enclosures needed for system 100. Alternative form factors include separate enclosures that house EV car chargers or other multi source backup inverters.

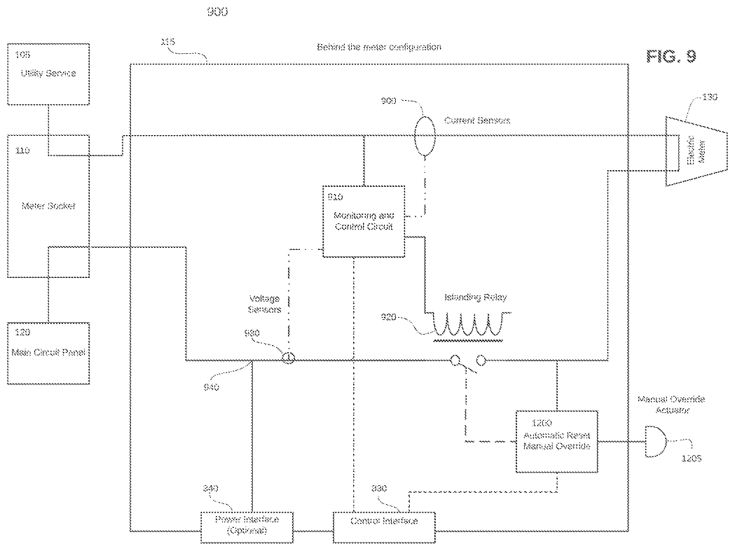

In accordance with one example operational flow, as described and recited herein, power may be supplied to electric vehicle charger interface 150, via utility service 105, meter socket 110, islanding meter socket adaptor 115, and wires 140; and communications in the form of digital or analog signals from, e.g., monitoring and control circuit 910 (see FIG. 9), to enable or disable the connection of the electric vehicle backup source 155 may supplied be to electric vehicle charger interface 150 via wires 145. In addition, control interface 145 may communicate with the electric vehicle inverter 155 to modify the inverters parameters including, but not limited to, power output level or power factor compensation.

In accordance with at least one example implementation, power may be routed directly from load 125 side of islanding meter socket adaptor 115 to electric vehicle charger interface 150. In accordance with at least one additional or alternative implementation, electric vehicle 155 may supply power to the grid or to loads 125. The aforementioned implementations may be enacted depending on program settings, determined by the local utility regulations and end user inputs, programed into the monitoring and control circuit (see FIG. 9).

In accordance with a non-limiting example implementation, in the event of a grid outage, islanding meter socket adaptor 115 may be configured to disconnect from the grid, i.e., utility service 100, while maintaining an electrical connection to electric vehicle charger interface 150 as well as electric vehicle 155 and to service panel 120, thereby supplying power from electric vehicle 155 to loads 125. Islanding meter socket adaptor 115 may be configured to inform the electrical vehicle charger interface 150 that the islanding relay contacts are open by sending a signal over the control interface 145. Accordingly, electrical vehicle charger interface 150 may enable the grid forming power 740 supply by switching the grid forming switch 715 to the electric vehicle grid forming interface 740 position to energize the power connection and pick up the service panel loads 125.

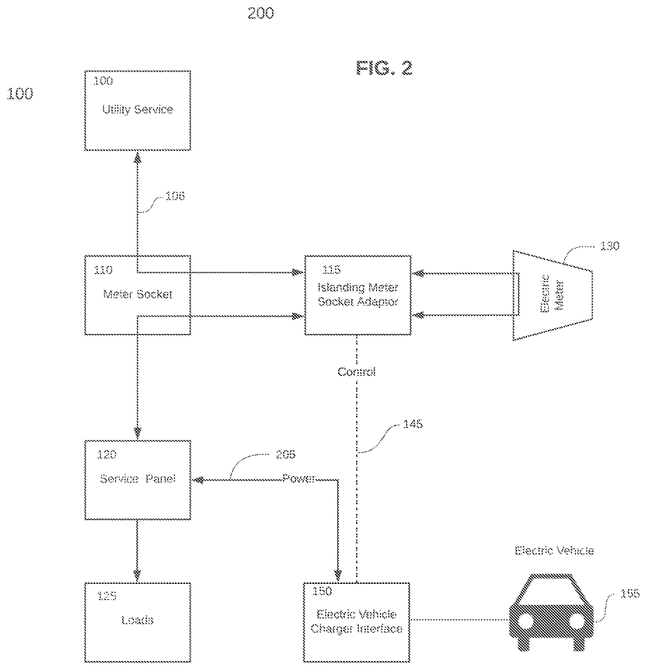

FIG. 2 shows a schematic drawing of a power distribution system, in accordance with at least one other example embodiment described and recited herein. As depicted, similar to system 100, system 200 includes, at least, utility service 105, meter socket 110, islanding meter socket adaptor 115, service panel 120, loads 125, electric meter 130, electric vehicle charger interface 150, and electric vehicle 155.

In accordance with at least one example embodiment, power lines 205 electrically connect charger interface 150 and service panel 120. In at least one example implementation, charger interface supports charging of electric vehicle 155 as well as, in accordance with at least one additional or alternative implementation, discharging of electric vehicle 155 to supply power to loads 125 or to feed power back to utility service 105, i.e., the grid. That is, in the event of a power outage, a relay within Islanding Meter Socket Adapter 115 may open to disconnect all downstream components from the grid, thus enabling EV 155 to provide backup power to loads 125.

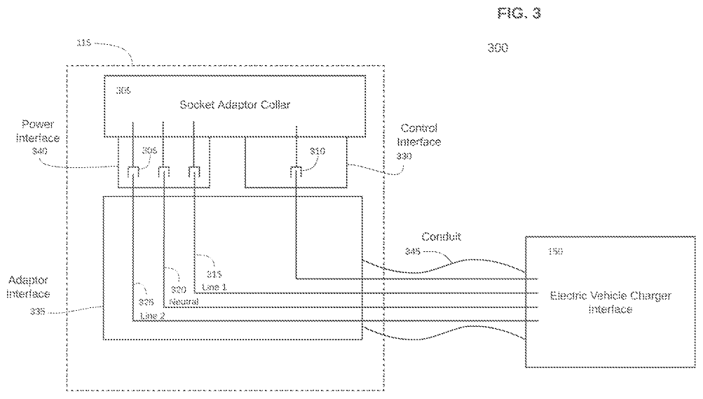

FIG. 3 shows a schematic drawing of an energy storage system, in accordance with at least one example embodiment described and recited herein. That is, FIG. 3 shows islanding meter socket adaptor 115 interconnected at a site with electrical loads on a grid side circuit interconnection point, with power flowing between the grid, the site, and the energy storage system.

System 300 includes islanding meter socket adaptor 115 electrically connected to electric vehicle charger interface 150. As depicted, islanding meter socket adaptor 115 includes, at least, socket adaptor collar 305, control interface 330, adaptor interface 335, power interface 340, and conduit 345.

Adaptor interface 335 houses the mating connectors for the power and control interfaces which may be electrically connected to socket adaptor collar 305, via power interface 340, which may have plug type connectors for, e.g., AC power Line 1 (315), Line 2 (325), and Neutral (320).

Socket adaptor collar 305 may be implemented as a meter socket adaptor depicted in FIG. 14A. The meter socket adaptor houses the islanding relay 920 and, when mounted in meter socket 110, facilitates its insertion between the utility service 100 and the service panel 120 and further provides a location for the backup power supply connection facilitated by the mating of the adaptor interface 335 and power interface 340.

Control interface 330 may be integrated with the islanding meter socket adaptor 115 collar and houses the connectors used to route the control IO signals from the islanding meter socket adaptor 115 collar to the adaptor interface 335 through the connections 310. This communication is used to control the grid forming switch 715. In addition, the communications may control EV backup source 155 to vary its output based upon desired system setpoints. The communications may be implemented in many forms including but not limited to digital IO, analog IO, and industrial standard serial protocols.

Power interface 340 may be configured to house pluggable connectors 305 designed to pass backup power to the socket adaptor collar 305. These connectors are appropriately sized to pass voltage and current required for the backup power level. Typical electric vehicle backup sources could provide up to 24,000 Watts or more of power to the private facility. For a 240 Volt service this would require connectors capable of carrying up to 100 amps of current.

Conduit 345 may be provided to facilitate AC power connectivity between islanding meter socket adaptor 115 and electric vehicle charger interface 150.

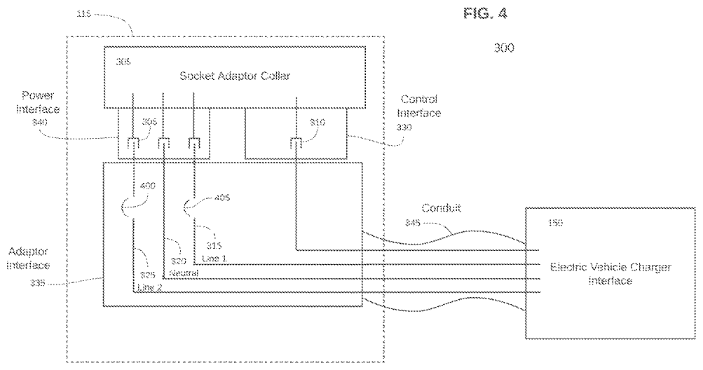

FIG. 4 shows a schematic drawing of an alternative embodiment of 300, in accordance with at least one other example embodiment described and recited herein.

As depicted in FIG. 4, system 300 further includes circuit breakers 400 and 405 that are integrated into the adaptor interface 335 providing circuit protection. Since socket adaptor 115 facilitates a power connection directly to utility service entrance at the meter socket 110, circuit protection is provided between the service entrance connection 110 and the electric vehicle backup source 155 as close as practical to the service entrance at the meter socket 110. The adaptor interface 335 is a convenient location to place this circuit protection since it is close to the service entrance and it can be easily replaced if needed. The circuit protection can consist of, but is not limited to, circuit breaks or fuses rated for the power flow being provided by the backup source.

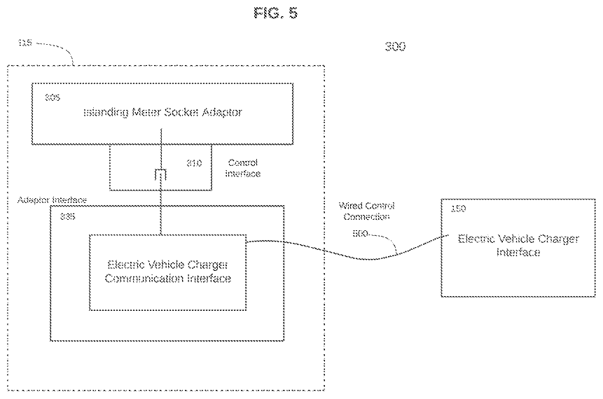

FIG. 5 shows a schematic drawings of a communications path corresponding at least one example embodiment of system 300, as described and recited herein.

As depicted in FIG. 5, system 300 includes islanding meter socket adaptor 115 electrically connected to electric vehicle charger interface 150. As depicted, islanding meter socket adaptor 115 includes, at least, socket adaptor collar 305, control interface 330, adaptor interface 335, power interface 340, and conduit 345.

Control interface 310 may facilitate a communications connection between islanding meter socket adaptor 305 and electrical vehicle charger communication interface 335. Control interface 310 is the connection point for IO signals that inform electrical vehicle charger interface 150 of the islanding relay status and interactively communicate with the EV backup supply 155. This connection may be made with a multi-pin low power signaling connector. Low power electrical signals are typically below the thresholds for limited power circuits as defined by the National Electric Code (NEC).

Wired control connection 500 is one method for establishing a signaling connection between electric vehicle charger communication interface 335 and electric vehicle charger interface 150. Wired control connection 500 may carry IO signals and communication traffic between the monitoring and control circuitry 910 to electrical vehicle charger interface 150.

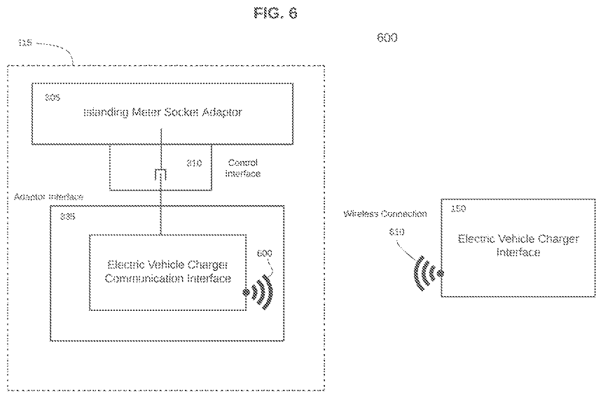

FIG. 6 shows a Schematic drawing of an alternative embodiment of system 300, as described and recited herein.

As depicted in FIG. 6, system 300 further includes wireless communications path 610 to 600 between electric vehicle charger communication interface 335 and electric vehicle charger interface 150. Further, control interface plug 310 may be provided to electrically connect islanding meter socket adaptor 305 and electric vehicle charger communication interface 335. Wireless communications protocols implemented between wireless interfaces 600 and 610 may include, but not be limited to, Wi-Fi, PLC, BPL, etc.

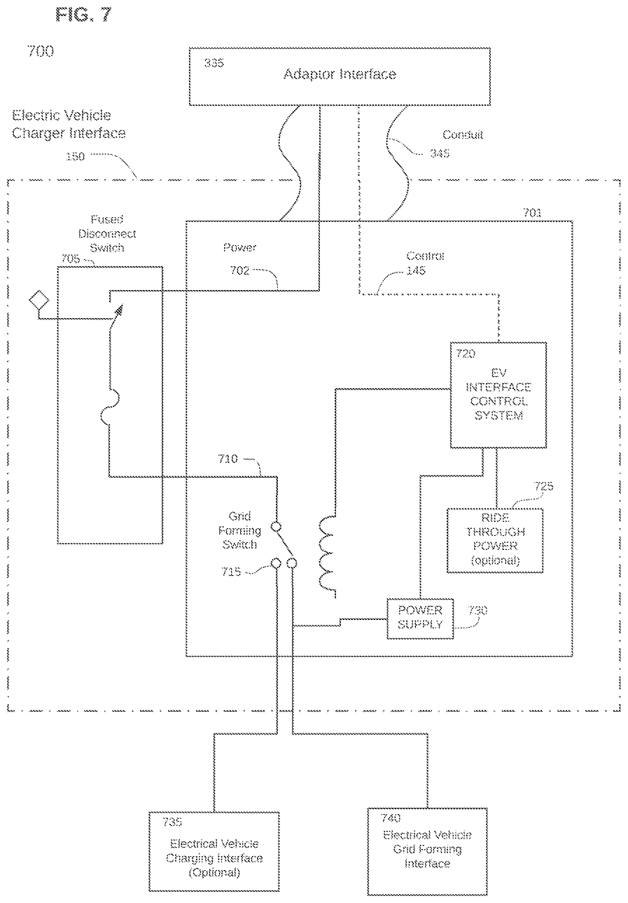

FIG. 7 shows a schematic drawing of the electric vehicle charger interface, in accordance with at least one example embodiment described and recited herein.

Electric vehicle charger interface 150 may be configured or designed to switch between normal grid-based vehicle charging and electrical vehicle-to-grid, or other backup power sourcing, protocols. Electrical vehicle charger interface 150 may reside in a separate enclosure that provides the interconnection between islanding meter socket adaptor 115 and the electric vehicle. The electrical vehicle charger interface houses the components needed to transfer the power connection to the grid forming interface in the event of a utility power outage.

As depicted in FIG. 7, electric vehicle charger interface 150 may include fused disconnect switch 705, grid forming switch enclosure 701, which houses the grid forming switch 715, electric vehicle interface control system 720, ride-through power 725, power supply 730. The electric vehicle charger interface provides terminal connections for the electric vehicle charging interface 735, and electric vehicle grid-forming interface 740.

Based on data regarding grid power status received via adaptor interface 115, electric vehicle charger interface 150 may operate internal grid forming switch 715 to charge electric vehicle 155; alternatively, based on the data regarding grid power status received via adaptor interface 115, electric vehicle charger interface 150 may operate internal grid forming switch 715 to switch to islanding mode for devices capable of operating in islanding mode.

As referenced in the description and recitation herein, islanding may refer to the disconnection of the service panel 120 from a utility service such that the service panel 120 may be energized from EV backup source 155 through the islanding meter socket adaptor 115 without back feeding power onto the utility service.

Electric vehicle charger interface 150 may be powered either by power supply 730, which may be electrically connected to the electric vehicle grid forming interface 740, or by ride through power 725 located in the electric vehicle charger interface. Ride though power 725 may be included with the electric vehicle charger interface 150 to power the EV Interface Control system in the event that there is no utility or backup power and it is desired to keep the control system powered for status communications or indications. In this regard, vehicle charger interface electric vehicle charger interface 735 also includes fused disconnect switch 705, which provides circuit protection for the service entrance conductors 106 and additionally gives a visible disconnect for service personnel to open in for system maintenance.

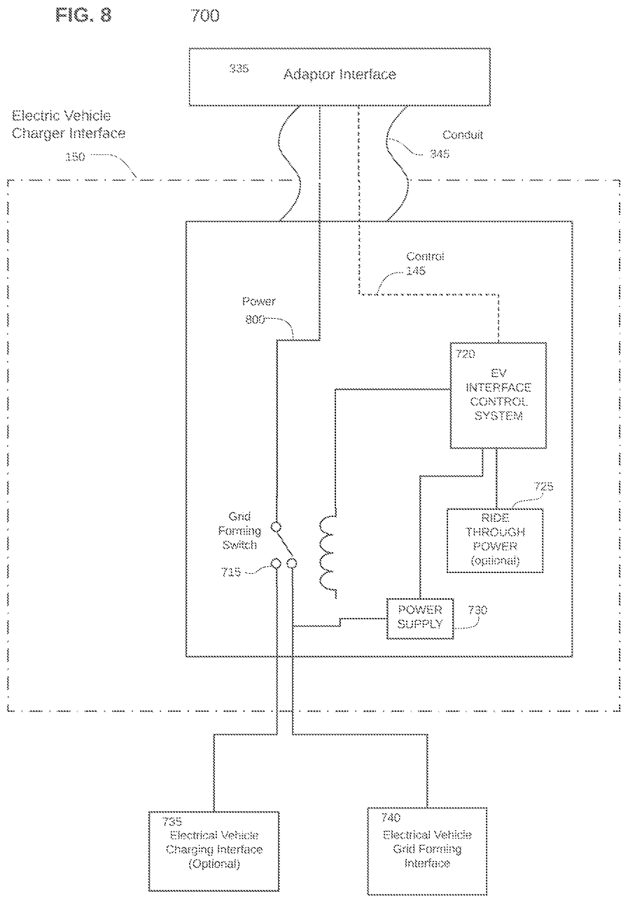

FIG. 8 shows schematic drawing of an alternative embodiment of electric vehicle charger interface 700, in accordance with at least one other example embodiment described and recited herein.

As depicted in FIG. 8, system 700 does not include a fused disconnect switch. Accordingly, the fusing means would be integrated into the Adaptor Interface as shown in FIG. 4. By incorporating the circuit protection in adaptor interface 335, the fusible disconnect is no longer needed, thus reducing a number of components in the system.

FIG. 9 shows a schematic drawing of a socket adaptor in accordance with at least one example embodiment described and recited herein.

FIG. 9 depicts what may be referred to, as a non-limiting example, an islanding meter socket adaptor (IMSA), in accordance with a “behind the meter” (BTM) configuration.

As referenced herein, behind the meter refers to a configuration by which islanding relay 920 is located on a common electric side of electric meter 130 as main service panel 120. Accordingly, main service panel 120 may be electrically isolated from utility service 105, and thus power may be supplied through power interface 340 to supply loads wired into the main service panel 120. While islanding relay 920 may be open, power supplied through power interface 340 is not metered by electric meter 130. In this configuration, the backup source is usually provided by the facility owner and the generated power should not be recorded or billed by the utility. In addition, the backup power will not energize utility service 105, ensuring safety of maintenance personnel that may be handling components at utility service 105 during a utility power outage.

Islanding meter socket adaptor (hereafter “IMSA”) 115 may couple electrically with meter socket 110 and also couple electrically with electric meter 130. Utility power may flow from utility service 105 to the meter socket 110, to IMSA 115, through electric meter 130, through islanding relay 920, to meter socket 110, and ultimately to the service panel 120 to power the connected loads. The islanding relay 920 is a latching relay that disconnects the utility power lines from the main service panel thus electrically islanding the main service panel from the utility service. Power can also flow in either direction from the adaptor interface 335 through power interface 340 to the power interconnection point 940. If a load is connected to the power interface, power will flow out of interconnection point 940 to supply the load. For example, a car charger will consume power to charge the electric vehicle batteries. If a power source is connected to the power interface, the power can flow into connection point 940. For example, a backup generator can source power that will flow into the connection point and supply the service panel loads.

The IMSA 115 contains a monitoring and control circuit 910 that operates in concert with other control logic accessed through the control interface 330 to operate the islanding relay 920 in accordance with the logic depicted in FIG. 11. The control circuit's 210 power supply is auctioneered, meaning whichever power source is energized may power the circuit, whether the utility service inlet and the control interface 225 power line. This allows the control circuit to operate when either utility power 100 or the EV grid forming source 600 is online. In addition to controlling the relay, monitoring and control circuit 910 measures current sensors 900 and voltage sensors 930 to provide input into the control logic for operation of islanding relay 920 and information for auxiliary functions such as, but not limited to, controlling the power output of the EV backup source 155.

If control circuit 910 fails, the islanding relay 920 has the capability to be overridden by a manual override actuator 1205 which is externally accessible on the IMSA. The IMSA also contains an Automatic Reset Manual Override (ARMO) 1200 that will open and disable the manual override of the islanding relay 920. The ARMO 1200 only allows the islanding relay 920 to be overridden shut when both the electric vehicle power source is disconnected from the adaptor interface 335 and power is present on the utility service 100. This is an additional safety feature to prevent the Utility service 100 from being energized through the adaptor interface 335 when there is a power outage and maintenance is being performed on the utility system. The ARMO 1200 is totally separate from the control circuit 910 and is powered by the utility line so it will not be affected by a failure in the control circuit 910. The ARMO 1200 also provides override status to the control system for use in the control logic.

In addition to monitoring the current flowing from the Utility service 100, the Current sensors 900 can provide circuit protection for the service entrance components. When power is being supplied to the standard main service panel 120 and to an additional load through the power interface 340 it is possible to overload the meter socket 110 and utility service 100 drop. Typically, standard service panels include a main circuit protection device that are sized to the maximum service drop rating. In the event that the main service panel 120 draws the maximum amount of power from the service drop and an additional load is then connected to the interface adaptor power interface 340, the standard meter socket adaptor 110 is in danger of being overloaded. In this case, the current sensors 900 are used to detect the total load being serviced by the utility service 110. If the load rating is exceeded the monitoring and control circuit 910 will either disconnect the additional load by opening the grid forming switch 715 or send a signal to the load to reduce its draw such that the total draw is below the utility service rating.

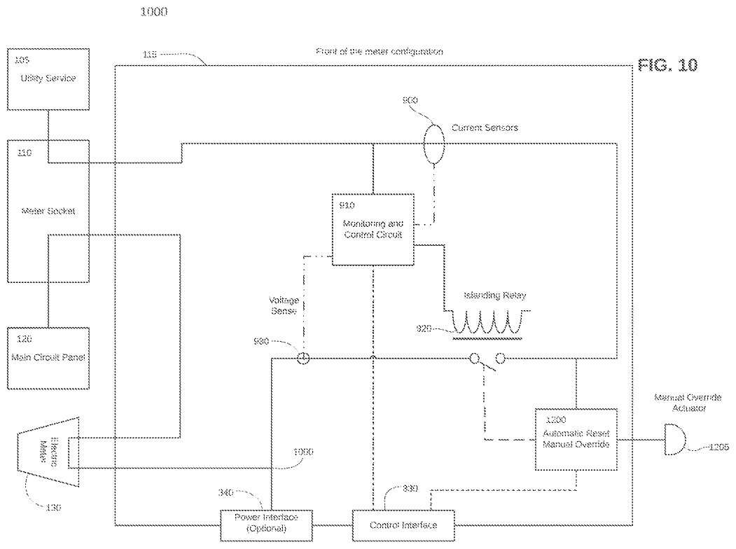

FIG. 10 shows a schematic drawing of a socket adaptor in accordance with at least one other example embodiment described and recited herein depicts the IMSA in the Front of The Meter (FTM) configuration. The components are essentially the same as the system depicted in FIG. 9 with the exception that the standard electric meter 130 is located on the other side of the islanding relay 920. This allows the power interface 340 to be connected to the utility service 100 side of the electric meter 130. This configuration is typically used when the power supply providing energy through the power interface 340 is considered a utility asset that can be metered through the standard electric meter 130 when the islanding relay 920 is open.

FIG. 11 shows an operation flow, in accordance with at least one example embodiment described and recited herein. The flow pertains to the resiliency logic used to operate the relays in the IMSA 115 and electric vehicle charger interface 150. This logic enables the safe application of electric vehicle grid forming power in the event of a utility power failure. It also prevents the power interface (Optional) 340 from being energized while the islanding adaptor interface 300 is unmated. This reduces the possibility of electric shock or spark while removing or mating the adaptor interface 335.

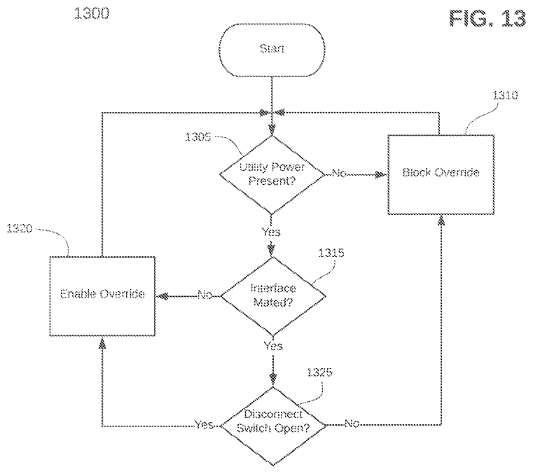

The logic starts 1100 when power is applied to the control circuit by either the Utility service 100 or the EV grid forming interface 740 source. Determining if the islanding relay 920 is manually overridden 1105 is the first decision. The ability to manually override the relay is controlled by the Automatic Reset Manual Override (ARMO) 1200 that operates in accordance with the logic depicted in FIG. 13. If the Islanding relay 920 is overridden, then the control system opens the grid forming relay 1140 contacts. If it is not overridden, then it continues to detect if a dummy adaptor interface is inserted 1110 into the IMSA 200.

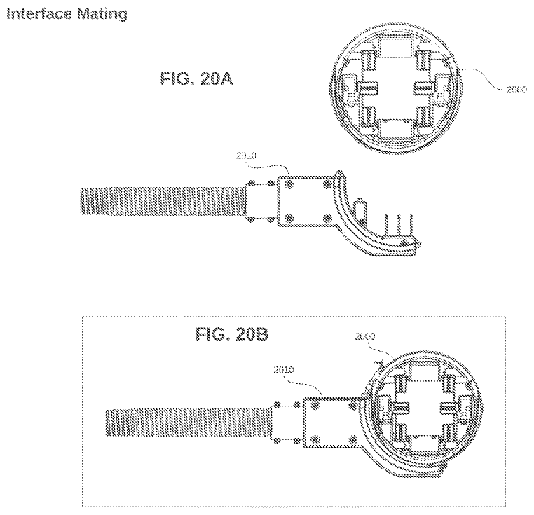

The dummy adaptor interface is used to safely cover the IMSA interface ports when an active adaptor interface 335 is not in service. If the dummy adaptor interface is inserted, then the islanding relay 920 is shut 1145 so utility power can flow to the standard main service panel 120. If the dummy interface is not in place, then the system detects if an active adaptor interface 335 is mated 1115 as shown in FIG. 20B

If the adaptor interface is not mated, then the control system opens the islanding relay 920 contacts 1130 thus de-energizing the power interface 340. If the adaptor interface 335 is mated, then the system detects if power from the utility service 105 is present 1120. If the power from the utility service 105 is not present, then it waits for a utility down delay timed out 1125.

The utility down delay timed out 1125 is intended to prevent rapid cycling of the relay system and EV power source in the event of short power interruptions. An example of a short interruption occurs when utility power is lost due to an intermittent short circuit that is subsequently cleared after a breaker reclosing cycle. These interruptions typically are only several seconds in duration.

If the utility power is still down after the delay time out, the control system opens the islanding relay contacts 1150 and then shuts the grid forming relay contacts 1135 thus enabling the grid forming EV source to power 135 the main service panel 120.

If utility power is present, the control system opens the grid forming relay contacts 1155 and then waits for a short delay 1160 to allow the loads on the main panel to fully drop. Transferring load too quickly can cause large system transients induced in inductive or capacitive loads that could trip power sources or circuit breakers. Once the load drop delay has expired, the islanding relay contacts are shut 1165 and the service panel 120 is powered from the Utility service 100.

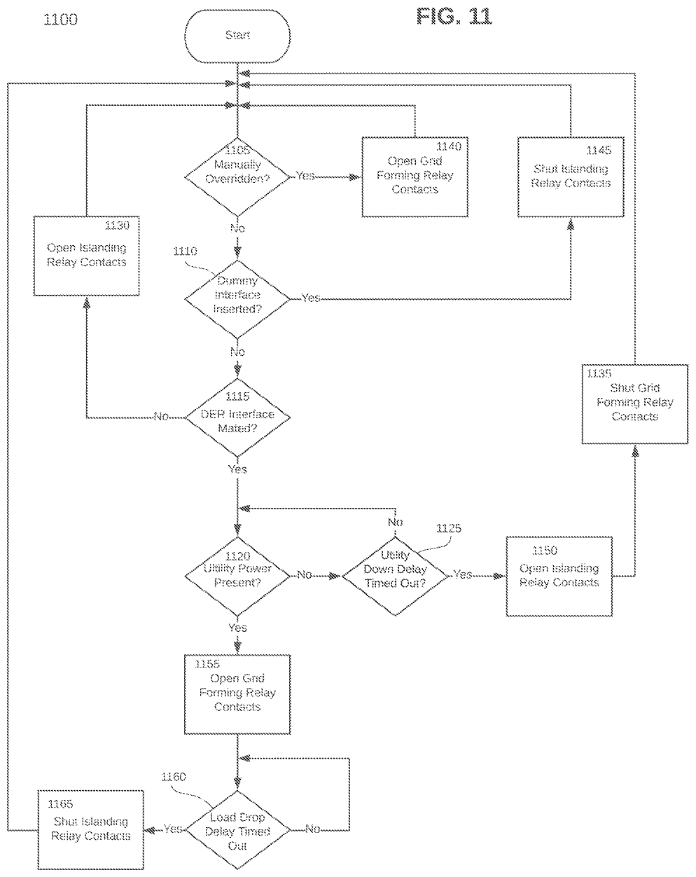

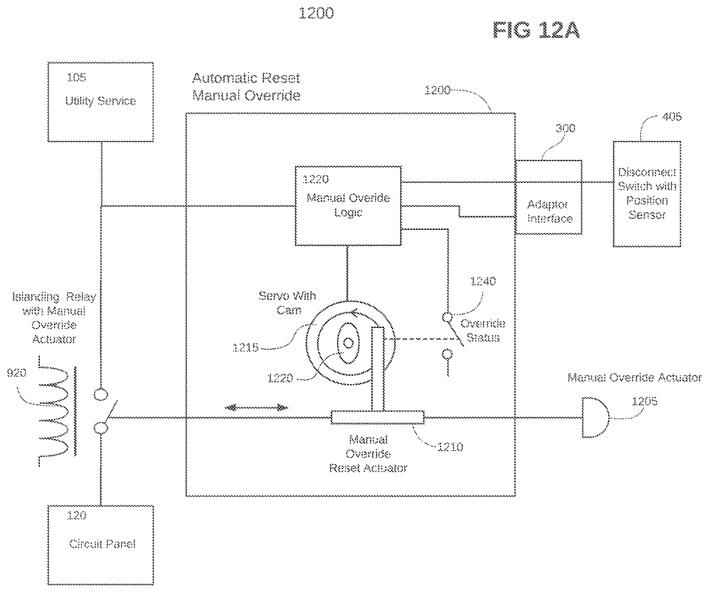

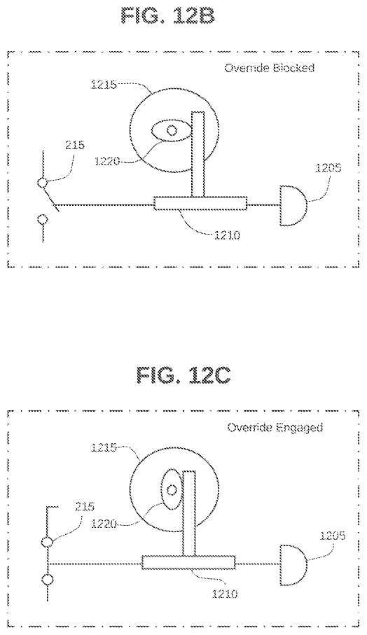

FIG. 12A Illustrates the automatic reset manual override (ARMO) 1200 component. This device allows for the manual operation of the Islanding relay 920 contacts under certain conditions. One possible condition is where the monitoring and control circuit 910 fails and the Islanding relay 920 is in the open position. If the utility power returns to service, the manual override actuator 1205 can be utilized to shut the islanding relay 920 contacts and restore power to the service panel 120.

The ARMO 1200 device is totally separate from the control circuit 210 so that failure in the control circuit is unlikely to affect the ARMO 1200 thus enabling power restoration if the utility power is present.

The ARMO 1200 will also automatically open and lockout the Islanding relay 920 contacts if utility power is lost. This prevents any power generation source that is connected to the load side of the islanding relay from feeding power back to the utility grid. This protects utility maintenance personnel from being exposed to energized components during a utility power outage.

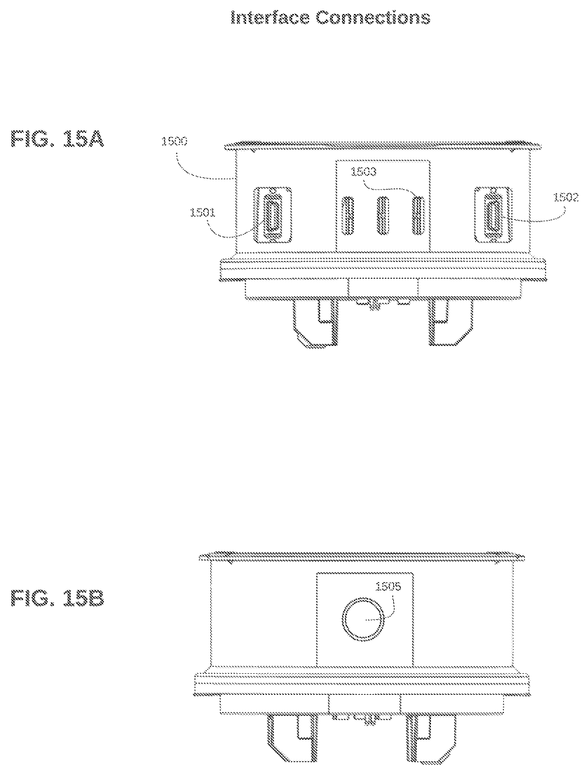

The ARMO can be reset and locked out by moving the manual override reset actuator 1210 with a cam device 1220 causing the ARMO to be disabled. The cam device 1220 is motivated by a servo or solenoid 1215 that is controlled by the manual override logic 1220 depicted in FIG. 15.

FIG. 12A shows the manual override reset actuator 1210 and servo with cam 1220 device in the position that enables shutting of the islanding relay 920 using the manual override actuator 1205.

FIG. 12B shows the manual override reset actuator 1210 and cam device 1220 in the position that locks out the ability to shut the islanding relay contacts 920 using the manual override actuator 1205.

FIG. 12C shows the manual override reset actuator 1210, the cam device 1220, and the islanding relay contacts 215 shut.

The override status switch 1240 indicates the position of the manual override actuator. This status can be used in the resilience logic depicted in FIG. 11.

FIG. 13 illustrates ARMO 1200 Logic. The system starts 1300 when power is applied to the logic. The first decision is to determine if utility power is present 1305.

If utility power is not present, the override opens the islanding relay contacts and blocks the override 1310 from being actuated. Opening the islanding contacts prevents any grid forming generator from feeding power to the grid while maintenance personnel could be exposed to energized components during a utility power outage.

If utility power is present, then it determines if an adaptor interface 335 is mated 1315 with the islanding meter socket adaptor 300.

If the interface is not mated, then the override is enabled 1320 allowing the islanding relay to be shut. When the interface is not mated there is no path for grid forming generator power to flow back to the utility therefore it is safe to override the islanding relay. If the interface is mated, then the system determines if the disconnect switch is open 1325.

If the disconnect switch is open, then the override is enabled 1320. When the disconnect is open there is no path for grid forming generator power to flow back to the utility therefore it is safe to override the islanding relay.

If the disconnect is shut, the override is blocked 1310 from being actuated. Blocking the override prevents any grid forming generator from feeding power to the grid while maintenance personnel could be exposed to energized components during a utility power outage.

FIG. 14A depicts one embodiment of the islanding meter socket adaptor.

FIG. 14B illustrates the enclosure 1400 and main power carrying components. The meter jaws 1408, 1407, 1409, 1410, 1405, the mate socket jaws 1411, 1412, 1413, and the islanding relay 1406.

FIG. 14C illustrates the control electronics enclosure 1423, electronics PCB 1422, and control interface connectors 1420, 1421.

FIG. 15A illustrates the control interfaces 1501, 1502, and the power interfaces 1503.

FIG. 15B illustrates the Automatic Reset Manual Override actuator 1505.

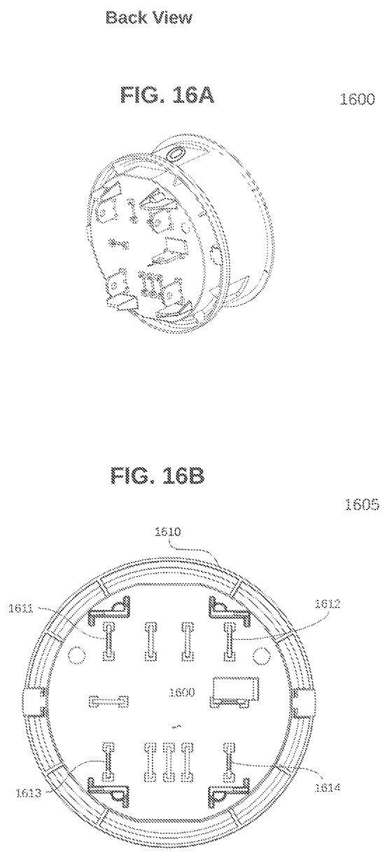

FIG. 16A depicts the back view of the meter socket adaptor this side mates with a standard meter socket.

FIG. 16B illustrates the meter socket adaptor enclosure 1610 back interface components including the meter socket stabs 1611, 1612, 1613, 1614.

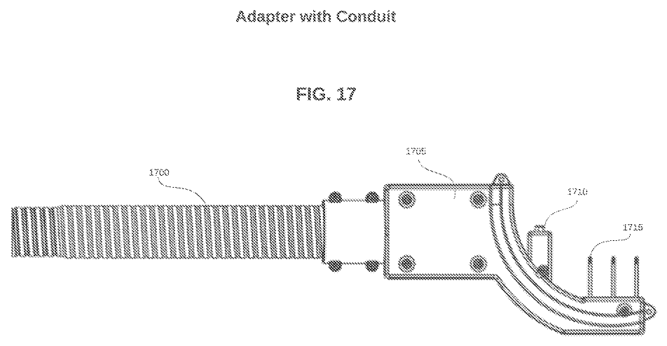

FIG. 17 illustrates the adaptor Interface 335 with a conduit 1700 to route the power and control cables to the electric vehicle charger interface 150. The other components are the interface casing 1705, the control interface connector 1710, and the power interface stabs 1715.

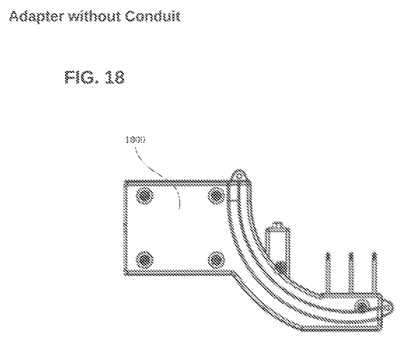

FIG. 18 depicts the Adaptor Interface 335 without power or control cabling routed to the electric vehicle charger interface 150. This embodiment shows the configuration utilizing wireless communications between the adaptor and charger.

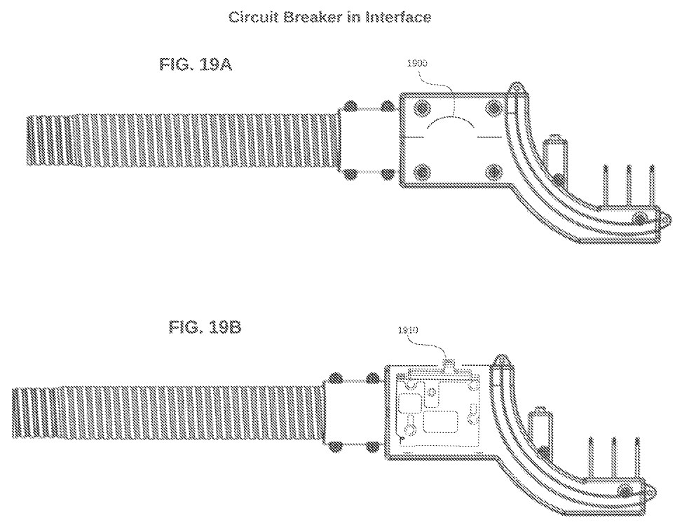

FIGS. 19A and 19B depict the adaptor with a disconnect and circuit protection devices in the adaptor 1900, 1910. This enables the system to be deployed without a separate fusible disconnect thus reducing the number of components needed to install at the site.

FIGS. 20A and 20B illustrate the mating of the interface adaptor 2010 and the meter socket adaptor 2000. FIG. 20A shows the adaptor unmated. FIG. 20B shows the adaptor mated.

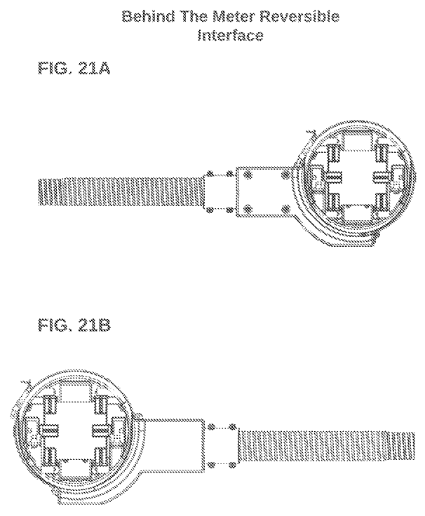

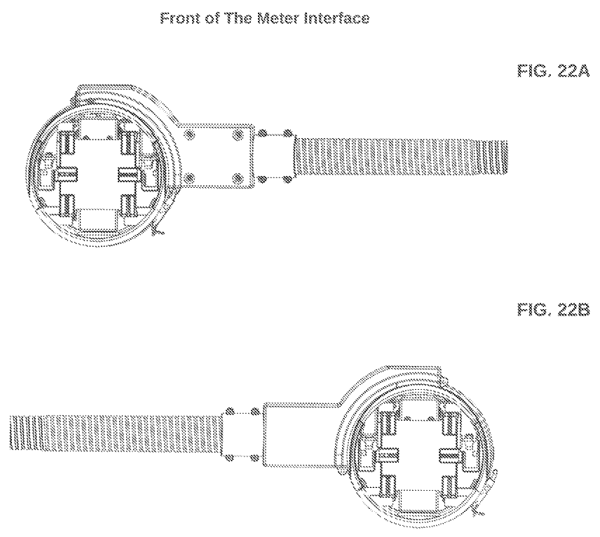

FIGS. 21A and 21B show the interface adaptor mated in two different directions. The interface adaptor is symmetrical so it can be mated such that the conduit exits in the right-hand or left-hand directions. This enables installation flexibility to ease the placement of the other system components and avoid potential interferences.

FIGS. 22A and 22B show the meter and interface adaptors rotated 180 degrees to enable a “front of the meter” (FTM) connection. This configuration is depicted in FIG. 10. This configuration can also mate in right-hand or left-hand configurations to facilitate installation.

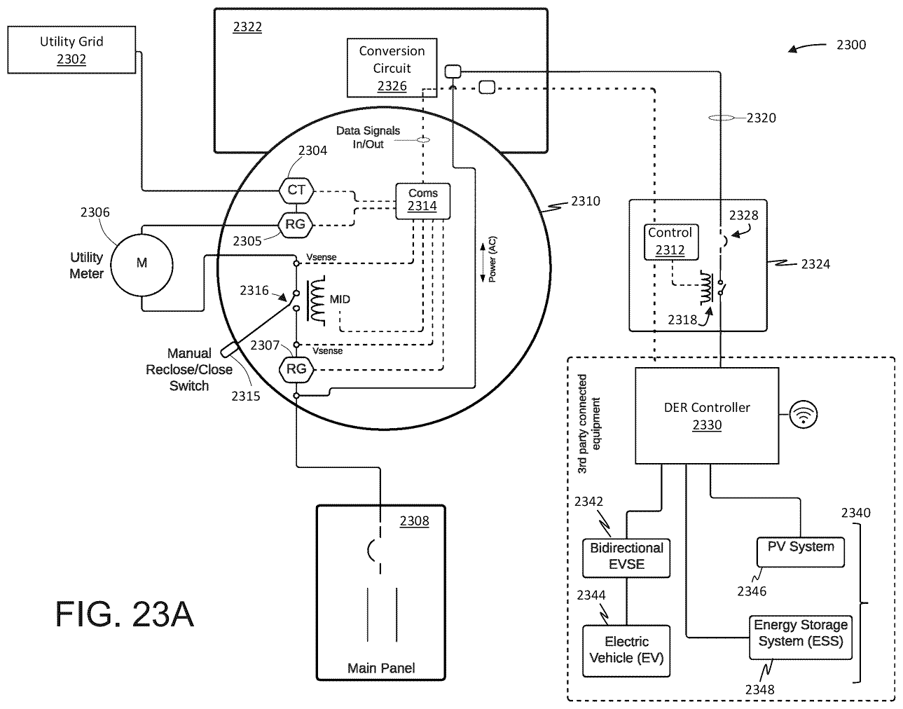

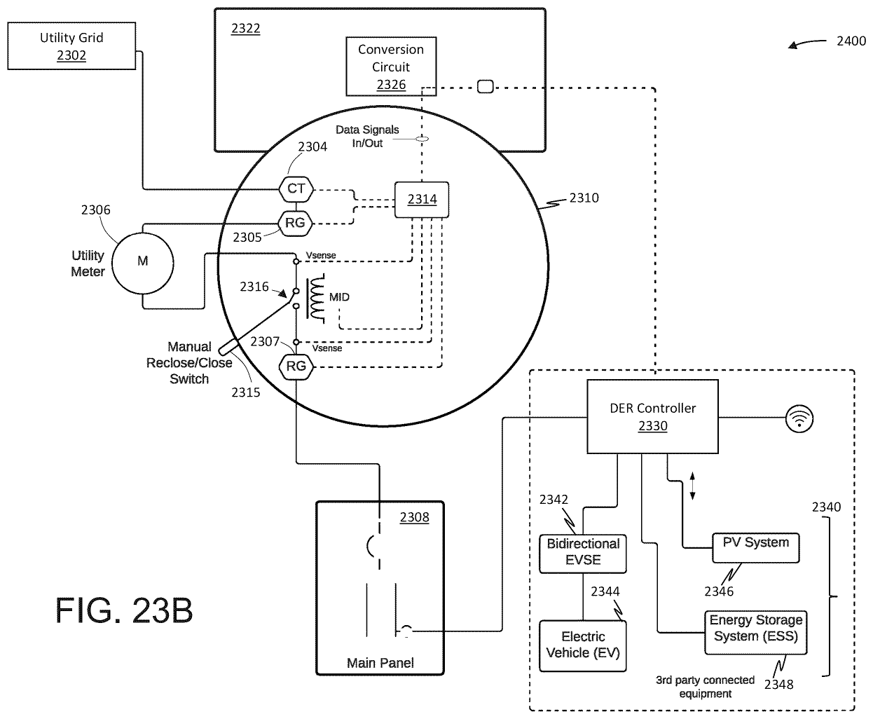

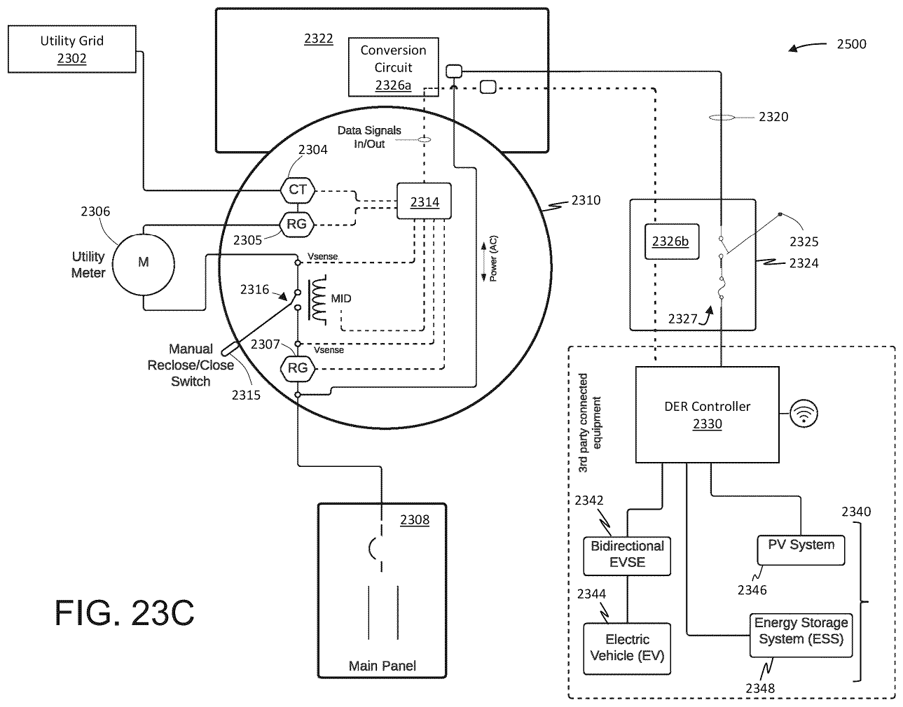

FIG. 23A illustrates an example system 2300 including a meter socket adapter (MSA) 2310 and an additional housing 2324 including a control circuit 2312. The MSA 2310 may facilitate the connection of one or more bidirectional distributed energy resources (DERs) 2340 to a main panel 2308 and a utility grid 2302. The main panel 2308 may be a main electrical panel of a building, such as a house. The utility grid 2302 may be a utility electrical grid, also referred to as “the grid.” The MSA 2310 may electrically connect the DERs 2340, the utility grid 2302, and/or the main panel 2308 and control the connection of the main panel 2308 to the utility grid 2302 and the DERs 2340.

The DERs 2340 may include one or more DERs, such as bi-directional electric vehicle supply equipment (EVSE) 2342 connected to an electric vehicle (EV) 2344, a photovoltaic (PV) system 2346, and an energy storage system (ESS) 2348. The DERs 2340 may include other DERs than the examples listed here. The DERs 2340 may receive power from the utility grid 2302 and/or the main panel 2308 and/or deliver power to the utility grid 2302 and/or the main panel 2308. In the system 2300, the DERs 2340 are connected to the main panel 2308 and/or the utility grid 2302 via the MSA 2310.

The MSA 2310 may be configured to be coupled to a meter 2306. In some implementations, the MSA 2310 is configured to connect the meter 2306 to a meter socket electrically connected to the main panel 2308. In an example, the MSA 2310 occupies the meter socket and the MSA 2310 is between the meter socket and the meter 2306. The MSA 2310 may connect to main service conductors of the meter socket. The main service conductors may be configured to supply power to the building via the meter 2306. The MSA 2310 may include conductors to electrically connect the main service conductors of the meter socket to the utility grid 2302 and/or the DERs 2340. In an example, the MSA 2310 includes jaws to receive conductors of the meter 2306 and blades to couple with jaws of the meter socket.

The MSA 2310 includes a whole-building disconnect switch 2316. The whole-building disconnect switch 2316 may be a Microgrid Interconnect Device (MID) or Automatic Transfer Switch (ATS). The whole-building disconnect switch 2316 may be an inductor-driven switch. The whole-building disconnect switch 2316 may be part of the MSA 2310 and located inside the housing of the MSA 2310.

The MSA 2310 includes one or more sensors. The one or more sensors may measure current, voltage, power, reactive power, phase, frequency, temperature, status of internal components of the MSA 2310, and other characteristics. In some implementations, the one or more sensors measure a current, voltage, power, reactive power, phase, and frequency of the electricity received from the utility grid 2302. The one or more sensors can include a first current sensor 2304. The first current sensor 2304 can measure current from the utility grid 2302. The first current sensor 2304 can be between the utility grid 2302 and the utility meter 2306. The first current sensor 2304 can measure current passing through the MSA 2310 from the utility grid 2302 to the utility meter 2306. In some implementations, the first current sensor 2304 is a revenue-grade current transformer (CT) that provides revenue-grade measurements of current. In this way, the first current sensor 2304 can provide revenue-grade metering to the DERs 2340. In an example, the first current sensor 2304 provides revenue-grade metering for the PV system 2346 as the PV system provides power to the utility grid 2302.

The one or more sensors can include a second current sensor 2305. The second current sensor 2305 can be a Rogowski coil. The second current sensor 2305 can measure current from the utility grid 2302. The second current sensor 2305 can be between the utility grid 2302 and the utility meter 2306. The second current sensor 2305 can measure current passing through the MSA 2310 from the utility grid 2302 to the utility meter 2306. In this way, the second current sensor 2305 can provide redundant current sensing between the utility grid 2302 and the utility meter 2306. In some implementations, the current measurements from the first current sensor 2304 can be compared to the current measurements from the second current sensor 2305.

The one or more sensors can include a third current sensor 2307. The third current sensor 2307 can be a Rogowski coil. The third current sensor 2307 can measure current passing through the MSA 2310. The third current sensor 2307 can be between the utility meter 2306 and the main panel 2308. The third current sensor 2307 can measure current between the utility meter 2306 and the main panel 2308. In some implementations, the third current sensor 2307 measures current between the DERs 2340 and the main panel 2308 and/or the utility grid 2302. In this way, the one or more sensors measure current on both sides of the utility meter 2306. In some implementations, the third current sensor 2307 measures current on a building side of the whole-building disconnect switch 2316. In this way, the third current sensor 2307 can measure current between the main panel 2308 and the DERs 2340. In an example, when the whole-building disconnect switch 2316 has been actuated to disconnect the main panel 2308 from the utility grid 2302, the third current sensor 2307 measures current provided to the main panel 2308 from the DERS 2340. Disconnecting the main panel 2308 from the utility grid 2302 may be referred to as “islanding mode,” as discussed herein.

The one or more sensors include voltage sensors. The voltage sensors can measure voltage within the MSA 2310 on both sides of the whole-building disconnect switch 2316. The voltage sensors can measure voltage when the whole-building disconnect switch 2316 connects the utility grid 2302 to the main panel 2308 and when the whole-building disconnect switch 2316 disconnects the utility grid 2302 from the main panel 2308. When the whole-building disconnect switch 2316 disconnects the main panel 2308 from the utility grid 2302, a first voltage sensor of the voltage sensors on a gird side of the whole-building disconnect switch 2316 monitors grid voltage of the utility grid 2302 and a second voltage sensor of the voltage sensors measures voltage from the main panel 2308 and/or the DERs 2340. In an example, the first voltage sensor monitors the grid voltage when the main panel 2308 is disconnected from the grid 2302 and the second voltage sensor measures voltage on the microgrid including the main panel 2308 and the DERs 2340.

The one or more sensors can include a temperature sensor and status sensors. The temperature sensor can measure an internal temperature of the MSA 2310. In an example, the DER controller 2330 reduces an amount of power provided by the DERS 2340 via the MSA 2310 based on the internal temperature of the MSA 2310 being higher than a predetermined threshold. In an example, the DER controller 2330 controls the DERs 2340 based on a status of the whole-building disconnect switch 2316 being open or closed.

The MSA 2310 includes a communication circuit 2314. The communication circuit 2314 is configured to transmit measurements from the one or more sensors to the DERs 2340 and/or a DER controller 2330. The DER controller 2330 may control the DERs 2340 and/or a flow of power to and/or from the DERs 2340. The DER controller 2330 can include a power control system (PCS) to control the DERs 2340 and a flow a power to and/or from the DERs 2340. The DER controller 2330 can also be referred to as co-located electrical equipment. The DER controller 2330 may determine when to actuate the whole-building disconnect switch 2316. The DER controller 2330 may determine when to actuate the whole-building disconnect switch 2316 based on information received from the communication circuit 2314. The communication circuit 2314 may transmit measurements of voltage of the utility grid 2302 to the DER controller 2330. The communication circuit 2314 can transmit measurements of voltage of the utility grid 2302 to the DER controller 2330 when the main panel 2308 is connected to the utility grid 2302 and when the main panel 2308 is disconnected from the utility grid 2302. In an example, the communication circuit 2314 transmits measurements of voltage of the utility grid 2302 to the DER controller 2330 when the main panel 2308 is disconnected from the utility grid 2302 such that the DER controller 2330 can determine when the grid starts providing power after an outage to determine when the actuate the whole-building disconnect switch 2316 to reconnect the main panel 2308 to the utility grid 2302.

The communication circuit 2314 may transmit the current measurements from the one or more sensors to the DER controller 2330. In some implementations, the DER controller 2330 uses the current measurements to control the DERs 2340. In an example, the DER controller 2330 compares a total current passing through the MSA 2310 to a current rating of the main panel 2308 and reduces power from the DERS 2340 based on the total current exceeding a predetermined threshold (e.g., based on the current rating of the main panel 2308).

The communication circuit 2314 may transmit current measurements from the third current sensor 2307 and voltage measurements from the second voltage sensor between the whole-building disconnect switch 2316 and the main panel 2308 to provide current and voltage measurements of the microgrid including the main panel 2308 and the DERs 2340. When the whole-building disconnect switch 2316 disconnects the main panel 2308 from the utility grid 2302, the microgrid is formed including the main panel 2308 and the DERs 2340. The DER controller 2330 may use the rent and voltage measurements of the microgrid to control the DERs 2340 to provide power to the main panel 2308.

The DER controller 2330 can provide a disconnect signal to the communication circuit 2314 to actuate the whole-building disconnect switch 2316. The DER controller 2330 can provide the disconnect signal based on an outage on the utility grid 2302, as determined based on the measurements from the communication circuit 2314. In some implementations, the carryover from grid power to microgrid power for the main panel 2308 is a blinkless carryover. A blinkless carryover may be a carryover that is imperceptible, or near-imperceptible to the human eye. In an example, a blinkless carryover is a carryover from utility grid power to microgrid power that is so rapid that the human eye does not perceive a blinking or dimming of light sources. In some implementations, the blinkless carryover involves an interruption of power to the main panel 2308 of less than 33 milliseconds, or less than 15 milliseconds. To provide the blinkless carryover, the communication circuit 2314 provides real-time current and voltage measurements to the DER controller 2330 and the whole-building disconnect switch 2316 actuates quickly in response to the disconnect signal.

The whole-building disconnect switch 2316 may be coupled to a manual switch 2315. The manual switch 2315 may allow for manual operation of the whole-building disconnect switch 2316. In an example, service personnel may actuate the manual switch 2315 to reconnect the main panel 2308 to the utility grid 2302 upon restoration of utility grid power. The communication circuit 2314 and/or the DER Controller 2330 may allow or prevent reconnecting the main panel 2308 to the utility grid 2302 using the manual switch 2315 based on one or more characteristics of the utility grid 2302 as transmitted to the DER controller 2330 by the communication circuit 2314. In an example, the DER Controller 2330 may prevent reconnecting the main panel 2308 to the utility grid 2302 using the manual switch 2315 based on an interruption of power or outage on the utility grid 2302. In this way, the DER Controller 2330 can enforce backfeed prevention to the utility grid 2302 during an outage on the utility grid 2302. In some implementations, the manual switch 2315 may be located under a tool-access cover on the exterior of the meter socket adapter 2310. The one or more sensors may monitor a status of the manual switch 2315 and/or the tool-access cover for the manual switch 2315. In some implementations, the one or more sensors can measure when the tool-access cover is removed such that the communication circuit 2314 can send an alert to the DER controller 2330 indicating access to the manual switch 2315. In response to the alert, the DER controller 2330 can deenergize connected the DERs 2340. In some implementations, actuation of the manual switch 2315 to reconnect the main panel 2308 to the utility grid 2302 is mediated by the DER Controller 2330 while actuation of the manual switch 2315 to disconnect the main panel 2308 from the utility grid 2302 directly disconnects the main panel 2308 from the utility grid 2302.

The communication circuit 2314 and/or the DER Controller 2330 may conduct logic checks for actuation of the whole-building disconnect switch 2316, including but not limited to voltage, current, and frequency logic checks based on measurements from the one or more sensors of the MSA 2310. The logic checks may allow for safe third-party synchronous operation of the whole-building disconnect switch 2316, third-party dynamic load balancing/throttling on the DERS 2340, or other power control/energy management functions. Third-party operation of the whole-building disconnect switch 2316 cannot override embedded safety based logic rules. In an example, as discussed herein, the whole-building disconnect switch 2316 cannot reclose into a lack of utility voltage. In an example, the communication circuit 2314 and/or the DER Controller 2330 may conduct a logic check to determine a voltage at the utility grid 2302 before allowing for connection to the utility grid 2302.

The additional housing 2324 may enclose a DER disconnect switch 2318 to disconnect the DERs 2340 and/or the DER controller 2330 from the main panel 2308 and/or utility grid 2302. The additional housing 2324 may be separate from the MSA 2310 and connected via one or more electrical connections. The additional housing 2324 may be an electrical auxiliary box. In an example, the additional housing 2324 is an auxiliary box mounted on a wall adjacent the MSA 2314. The additional housing may enclose a control circuit 2312. The control circuit 2312 may monitor a current through the additional housing 2324 and/or through the MSA 2310. The control circuit 2312 may receive current and voltage measurements from the communication circuit 2314.

The control circuit 2312 can determine an overcurrent risk based on the current and voltage measurements from the communication circuit 2314. The control circuit 2312 may disconnect the DERs 2340 from the main panel 2308 by actuating the DER disconnect switch 2318. In an example, the control circuit 2312 actuates the DER disconnect switch 2318 in response to an overcurrent condition associated with the combined power consumption (e.g., total current and total voltage) of the main panel 2308 and any connected DERs 2340, such as charging an electric vehicle 2344. The control circuit 2312 may, when the DER disconnect switch 2318 has been actuated to disconnect the MSA from the DERs 2340, receive an indication of the combined power consumption (e.g., total current and total voltage) and, based on the total current, total voltage, or combined power consumption, actuate the DER disconnect switch 2318 to reconnect the MSA 2310 and the DERs 2340. In an example, the control circuit 2312 determines, based on an indication of total current provided to the main panel 2308, that the total current is below a predetermined threshold associated with an overcurrent risk and actuate the DER disconnect switch 2318 to reconnect the MSA 2310 and the DERs 2340/DER controller 2330.

In some implementations, the DER disconnect switch 2318 and/or the control circuit 2312 may be part of the MSA 2310 and located inside the housing of the MSA 2310. In some implementations, the additional housing 2324 includes multiple DER disconnect switches to disconnect the DERs 2340 from the main panel 2308. In an example, the additional housing 2324 includes a corresponding disconnect switch for each DER of the DERs 2340. In some implementations, the DER controller 2330 can disconnect one or more of the DERs 2340 from the MSA 2310. The DER controller 2330 may disconnect one or more of the DERs 2340 from the MSA 2310 by directly disconnecting the one or more of the DERs 2340 and/or by sending a disconnect command to the control circuit 2312 to actuate the DER disconnect switch 2318.

The DER controller 2330 may include an internal disconnect switch to directly disconnect the DERs 2340 from the main panel 2308. The DER controller 2330 may actuate disconnect switches of the DERs 2340 to disconnect individual DERs of the DERs 2340. In some implementations, the DER controller 2330 may disconnect one or more of the DERs 2340 from the MSA 2310 in response to data signals sent from communications module 2314. In some implementations, the additional housing 2324 may be a factory included enclosure (included with the MSA 2310 and/or pre-wired to the MSA 2310) that houses control circuit 2312, DER disconnect switch 2318, as well as overcurrent protection devices. In some implementations, the additional housing 2324 includes a circuit breaker 2328. The circuit breaker 2328 may be an additional protection against overcurrent. The circuit breaker 2328 may be an example of an overcurrent protection device.

In some implementations, the control circuit 2312 may protect the meter 2306, meter socket, and service entrance conductors from potential overcurrent due to the combined loads associated with the building and the DERs 2340. The control circuit 2312 may monitor a current passing through the meter socket adapter 2310. The control circuit 2312 may compare instantaneous and continuous current relative to the rating of components of the system 2300. In an example, the meter 2306, meter socket, and service entrance conductors have a maximum current rating of 200 amps, corresponding to a 200-amp circuit breaker in the main panel 2308 which prevents current from exceeding the maximum current rating of the meter 2306, meter socket, and service entrance conductors. However, in this example, when the DERs 2340 draw power from the utility grid 2302 via the meter 2306, more than 200 amps may be drawn from the utility grid 2302 without triggering the 200-amp circuit breaker of the main panel 2308. In this example, the control circuit 2312 may monitor the total current or power from the utility grid 2302 passing through the meter 2306 in order to determine whether the total current or power exceeds the maximum current rating of the meter 2306, meter socket, or service entrance conductors. In some implementations, the control circuit 2312 may monitor the current passing through to the main panel 2308 and the current passing through to the DERs 2340 to determine the total current passing through the meter 2306. In some implementations, the control circuit 2312 may temporarily disconnect the main panel 2308 from the utility grid 2302 and/or the DERs 2340 in order to prevent overcurrent.

In some implementations, the communication circuit 2314 may transmit additional data to the DER controller 2330. In some implementations, the additional data includes a status of components of the MSA 2310, a status of the utility grid 2302, power price information, weather forecasts, and other information. In an example, the communication circuit 2314 transmits power price information to the DER controller 2330 and the DER controller 2330 controls the DERs 2340 and/or actuates the whole-building disconnect switch 2316 to enter islanding mode based on the power price information.

In some implementations, the communication circuit 2314 may transmit current and voltage measurements as well as the additional information when the main panel 2308 is disconnected from the utility grid 2302 (e.g., during islanding mode). In an example, the DER controller 2330, using the data from the communication circuit 2314, monitors the utility grid 2302 to determine whether the utility grid is providing power and/or a cost of energy provided by the utility grid 2302. The DER controller 2330 may, based on the one or more characteristics of the utility grid 2302, reconnect the main panel 2308 to the utility grid 2302. In an example, the DER controller 2330 may reconnect the main panel 2308 to the utility grid 2302 when power is restored to the utility grid 2302. In an example, the DER controller 2330 may reconnect the main panel 2308 to the utility grid 2302 when the cost of energy provided by the utility grid 2302 falls below a predetermined threshold.

In some implementations, the communication circuit 2314, using the one or more sensors, may monitor one or more characteristics of the utility grid 2302 to determine that there is an interruption in grid power and send, via the communications module 2314, the one or more characteristics of the utility grid 2302 and/or the determination of the interruption in grid power to the DER controller 2330. In some implementations, the communication circuit 2314 does not determine whether there is an interruption in grid power and transmits the characteristics (e.g., measurements) of the utility grid 2302 to the DER controller 2330 for the DER controller 2330 to determine whether there is an interruption in grid power. The communication circuit 2314 may receive a command from the DER controller 2330 to actuate the whole-building disconnect switch 2316 to disconnect the main panel 2308 from the utility grid 2302. In an example, the communication circuit 2314 may monitor one or more characteristics of the utility grid 2302 and transmit the one or more characteristics of the utility grid 2302 to the DER controller 2330 to determine that there is a resumption of grid power. The DER controller 2330 can send a reconnect signal to the communication circuit 2314 to actuate the whole-building disconnect switch 2316 to reconnect the main panel 2308 to the utility grid 2302.

The communication circuit 2314 may have a wired connection or a wireless connection with the DER controller 2330 and/or the DERs 2340. The wired connection between the communication circuit 2314 and the DER controller 2330 may be included in a cable 2320 from the MSA 2310 to an additional housing 2324 electrically connected to the DER controller 2330. The cable 2320 may carry power and/or communication signals from the MSA 2310 to the DERs 2340 via the additional housing 2324 and the DER controller 2330. The cable 2320 may pass through a pluggable assembly 2322 coupled to the MSA 2310. The cable 2320 may be attached to the pluggable assembly 2322. The pluggable assembly 2322 may be configured to be plugged in to the MSA 2310, serving as a DER interface to connect the DERs 2340 to the MSA 2310. The pluggable assembly 2322 may include multiple sites for connecting cables such as the cable 2320 which serve as multiple DER interfaces to connect multiple DERs and/or multiple DER controllers 2330 to the MSA 2310. In an example, the MSA 2310 includes a first DER interface and a second DER interface for separate connections to separate DER controllers.

In some implementations, the pluggable assembly 2322 includes a conversion circuit 2326. In some implementations, the conversion circuit 2326 is a printed circuit board assembly (PCBA). In some implementations, the conversion circuit 2326 is part of a PCBA that converts analog signals originating from the one or more sensors of the MSA 2310. Functionality attributed herein to the conversion circuit 2326 may be performed by the PCBA, by another component of the PCBA, or by any combination of components of the PCBA. The conversion circuit 2326 may convert analog signals from the MSA 2310 to digital signals to be provided to the DER controller 2330. The conversion circuit 2326 may include a digital-analog converter (DAC) for converting the analog signals to digital signals. In some implementations, the conversion circuit 2326 converts the signals from the MSA 2310 into a format compatible with the DER controller 2330. In some implementations, the conversion circuit 2326 correlates different measurements for delivery to the DER controller 2330. In an example, the conversion circuit 2326 correlates voltage measurements and current measurements according to time to deliver current and voltage measurements for each measurement time to the DER controller 2330. By converting the analog signals from the MSA 2310 to digital signals, the conversion circuit 2326 allows the pluggable assembly 2322 to output digital signals which can travel farther than the corresponding analog signals. In an example, the pluggable assembly 2322 can have an ethernet connection (i.e., from an RJ45 connector) that carries the digital signals for hundreds of feet to the DER controller 2330, beyond a useful transmission range of the analog signals.

The conversion circuit 2326 (e.g., PCBA including the conversion circuit 2326) can be configured to convert the analog signals originating from the one or more sensors of the MSA 2310 into digital signals using different formats or protocols. The different formats or protocols can convert the analog signals differently such that the same analog signal could be converted or interpreted by the conversion circuit 2326 in different ways according to different formats or protocols. In an example, the conversion circuit 2326 can convert the analog signals from the MSA 2310 to digital communication protocols such as Modbus, CANbus, or other digital protocols. The conversion circuit 2326 can be configured to implement a digital communication protocol based on the protocol used by the DER controller 2330. In some implementations, the conversion circuit 2326 (PCBA including the conversion circuit 2326) is integrated with the pluggable assembly 2322. In some implementations, the pluggable assembly 2322 includes a receptacle (e.g., including mechanical and/or electrical connections) for the conversion circuit 2326 (PCBA including the conversion circuit 2326) such that any conversion circuit 2326 compatible with the receptacle (e.g., fits within the receptacle) can be inserted in the pluggable assembly 2322 for converting the analog signals from the MSA 2310 to digital signals for the DER controller 2330. In an example, the pluggable assembly 2322 is manufactured with an integrated conversion circuit 2326, such as a default conversion circuit 2326 that implements a predefined digital communication protocol. In an example, the pluggable assembly 2322 is manufactured to include a receptacle including mechanical supports for supporting the conversion circuit 2326, and the conversion circuit 2326 is manufactured by a manufacturer of the DER controller 2330 to be compatible with the DER controller 2330. In some implementations, the receptacle exposes a portion of the conversion circuit 2326 to electrically connect the conversion circuit 2326 to the MSA 2310 such that the conversion circuit 2326 can receive sensor signals from the MSA 2310. In an example, the pluggable assembly 2322 is manufactured to include a receptacle including mechanical supports and/or electrical connections for connecting to the conversion circuit 2326, and an end user can install a conversion circuit 2326 compatible with the DER controller 2330 and/or swap out conversion circuits based on a current DER controller being used.

The communication circuit 2314 may have a wireless connection with the DERs 2340 and/or the DER controller 2330. The wireless connection may use any communications protocol, such as WIFI™ or BLUETOOTH™.

The DER controller 2330 may, in response to a communications failure of the communications module 2314, disconnect the DERs 2340 from the main panel 2308. The communications failure may include the unsuccessful transmission of one or more messages between the communication circuit 2314 and the DERs 2340 and/or the DER controller 2330. In an example, the communication circuit 2314 ignores a command from the DER controller 2330 to actuate the whole-building disconnect switch 2316 (e.g., to reconnect the main panel 2308 to the utility grid 2302) in response to a failure of the DER controller 2330 to acknowledge a message from the communication circuit 2314. In an example, the DER controller 2330 disconnects the DERs 2340 from the MSA 2310 in response to a failure of the communication circuit 2314 to acknowledge a message from the DER controller 2330 or in response to a missing heartbeat from the communication circuit 2314.

The communication circuit 2314 may conduct logic checks to determine whether to execute the commands and/or control signals received from the DER controller 2330 and/or the DERs 2340. In an example, the communication circuit 2314 receives a command from the DER controller 2330 to reconnect the main panel 2308 to the utility grid 2302 and the communication circuit 2314 conducts logic checks to determine whether the utility grid 2302 is providing power in order to prevent backfeed to the grid 2302 if the grid is not providing power.

As discussed herein, the DER controller 2330 may control the DERs 2340 and the flow of power to and/or from the MSA 2310 based on the data provided by the communication circuit 2314. In some implementations, the primary protection against overcurrent is the DER controller 2330 (e.g., the PCS of the DER controller 2330). In an example, when the DER controller 2330 properly controls the DERs 2340 to avoid overcurrent at the main panel 2308 or the MSA 2310, the control circuit 2312 does not need to actuate the MSA disconnect switch 2318 and the circuit breaker 2328 is not tripped. However, if the DER controller 2330 does not successfully avoid an overcurrent condition or otherwise does not control the DERs 2340 to avoid an overcurrent condition or other unsafe condition, the control circuit 2312, the DER disconnect switch 2318, and/or the circuit breaker 2328 provide a second layer of safety and control to prevent overcurrent conditions at the main panel 2308 and/or the MSA 2310.

FIG. 23B illustrates an example system 2400 including a meter socket adapter 2310. The system 2400 can be the same as the system 2300 of FIG. 23A, with the exception that the system 2400 does not include the additional housing 2324, and the DER controller 2330 is connected directly to the main panel 2308, not via the MSA 2310. In the system 2400, the MSA 2310 does not provide power transmission between the utility grid 2302 and the DER controller 2330, as in the system 2300 of FIG. 23A. In the system 2400, the DER controller 2330 and/or the DERs 2340 are directly connected to the main panel 2308. In the system 2400, the MSA 2310 provide data to the DER controller 2330 and/or the DERs 2340, as discussed in FIG. 23A. The MSA 2310 may, using the communication circuit 2314, provide measurements from the one or more sensors of the MSA 2310 to the DER controller 2330 and/or the DERs 2340.

The data connection between the MSA 2310 and the DER controller 2330 in the system 2400 may function the same or similar to the data connection between the MSA 2310 and the DER controller 2330 in the system 2300 of FIG. 23A. The communication circuit 2314 can transmit measurements of voltage and/or current from the utility grid 2302 to the DER controller 2330, receive a disconnect signal from the DER controller 2330 based on the transmitted measurements, and actuate the whole-building disconnect switch 2315 in response to the disconnect signal.

In the system 2400, the additional housing 2324, and thus the control circuit 2314, are not present, and the DER controller 2330 is directly connected to the main panel 2308. Thus, the DER controller 2330 controls (as in the system 2300) the DERs 2340 to prevent an overcurrent condition at the main panel 2308 based on the information provided by the communication circuit 2314, but the backup safety mechanisms provided by the control circuit 2312 are not present. In an example, the DER controller 2330 determines, based on the voltage and current measurements from the MSA 2310, that a current through the MSA 2310 exceeds a predetermined threshold, and the DER controller 2330 disconnects the DERs 2340 from the main panel 2308 to avoid an overcurrent condition.

FIG. 23C illustrates an example system 2500 including a meter socket adapter MSA 2310 and an additional housing 2324. The system 2500 can be the same as the system 2300 of FIG. 23A, with the exception that in the system 2500, the additional housing 2324 does not include the DER disconnect switch 2318, the circuit breaker 2328, and the control circuit 2312 and instead includes a manual DER disconnect switch 2325, and a fuse 2327. Similar to the system 2400, as the system 2500 does not include the control circuit 2312, the DER controller 2330 controls (as in the system 2300) the DERs 2340 to prevent an overcurrent condition at the main panel 2308 and/or the MSA 2310 based on the information provided by the communication circuit 2314, but the backup safety mechanisms provided by the control circuit 2312 are not present. However, similar to the system 2300, the additional housing 2324 includes a mechanism for disconnecting the DER controller 2330 and/or the DERs 2340, albeit a manually actuated mechanism unlike the automatic actuation of the DER disconnect switch 2318 by the control circuit 2312 in the system 2300 of FIG. 23.

The manual DER disconnect switch 2325 allows users (e.g., service personnel) to manually disconnect the DER controller 2330 and the DERs 2340 from the MSA 2310, and thus from the main panel 2308 and/or the utility grid 2302. The manual DER disconnect switch 2325 may be similar to the circuit breaker 2328 of the system 2300 of FIG. 23A in that the manual DER disconnect switch 2325 and the circuit breaker 2328 allow for manual disconnection of the DERs 2340 from the MSA 2310, but the manual DER disconnect switch 2325 provides greater visibility and easier access for disconnecting the DERs 2340 from the MSA 2310. The fuse 2327 may provide a safety mechanism in the event of overcurrent conditions, serving to disconnect the DER controller 2330 and the DERs 2340 from the MSA 2310 if a current through the fuse 2327 exceeds a predetermined amount (i.e., a rating of the fuse 2327). In this way, control of the connection between the MSA 2310 and the DER controller 2330 is held by the DER controller 2330, with the manual DER disconnect switch 2325 and the fuse 2327 providing additional or alternative mechanisms for disconnecting the MSA 2310 and the DER controller 2330.

In some implementations, the pluggable assembly 2322 includes a first conversion circuit 2326a similar to the system 2300 of FIG. 23A. In some implementations, the pluggable assembly includes a second conversion circuit 2326b housed within the additional housing 2324. The first conversion circuit 2326a and/or the second conversion circuit 2326b can be similar to or the same as the conversion circuit 2326 of the system 2300 of FIG. 23A and can be part of a PCBA similar to or the same as the conversion circuit 2326 of the system 2300 of FIG. 23A. The first conversion circuit 2326s and the second conversion circuit 2326b can be the same or similar to each other. The system 2500 can include either the conversion circuit 2326a or the conversion circuit 2326b, or both. In some implementations, the first conversion circuit 2326a implements a first digital communication protocol to increase a transmission range of sensor readings from the MSA 2310 and the second conversion circuit 2326 implements a second digital communication protocol that is compatible with the DER controller 2330.

The additional housing 2324 can include a receptacle for the second conversion circuit 2326b similar to how the pluggable assembly 2322 includes a receptacle for the first conversion circuit 2326a. In some implementations, the receptacles of the pluggable assembly 2322 and the additional housing 2324 are the same or can receive the same conversion circuit. In this way, the same conversion circuit can be installed either in the pluggable assembly 2322 or in the additional housing 2324.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A meter socket adapter (MSA) including:
an integrated whole-building disconnect switch configured to disconnect a building associated with the MSA from a utility grid;
one or more sensors configured to capture measurements of grid voltage;
a communication circuit configured to:
transmit the measurements of grid voltage to co-located electrical equipment;
receive a disconnect signal from the co-located electrical equipment;
in response to the disconnect signal, actuate the whole-building disconnect switch to disconnect the building from the utility grid; and
in response to a reconnect signal, actuate the whole-building disconnect switch to connect the building to the utility grid.

2. The MSA of claim 1, wherein the one or more sensors are configured to capture measurements of current, phase, reactive power, and frequency.

3. The MSA of claim 1, wherein the communication circuit is configured to, in response to the reconnect signal, conduct one or more logic checks to determine to actuate the whole-building disconnect switch to connect the building to the utility grid.

4. The MSA of claim 1, wherein the one or more sensors include a sensor between the whole-building disconnect switch and a main building panel.

5. The MSA of claim 4, wherein the communication circuit is configured to transmit current and voltage measurements from the sensor between the whole-building disconnect switch and the main building panel.

6. The MSA of claim 1, further comprising a pluggable assembly to connect the communication circuit to the co-located electrical equipment.

7. The MSA of claim 6, wherein the pluggable assembly includes a conversion circuit to convert analog signals from the MSA to digital signals for the co-located electrical equipment.

8. The MSA of claim 6, wherein the pluggable assembly includes a receptacle to receive a conversion circuit to convert analog signals from the MSA to digital signals for the co-located electrical equipment.

9. The MSA of claim 1, wherein the communication circuit is configured to actuate the whole-building disconnect switch in response to the disconnect signal from the co-located electrical equipment such that the building undergoes a blinkless carryover from grid to microgrid.

10. The MSA of claim 1, wherein the communication circuit is configured to transmit an internal temperature of the MSA to the co-located electrical equipment.

11. A meter socket adapter (MSA) system including:
an MSA including:
an integrated whole-building disconnect switch configured to disconnect a building associated with the MSA from a utility grid;
a distributed energy resource (DER) interface to connect a distributed energy resource (DER) controller; and
a communication circuit configured to:
in response to a disconnect signal from the DER controller, actuate the whole-building disconnect switch to disconnect the building from the utility grid;
in response to a reconnect signal from the DER controller, actuate the whole-building disconnect switch to connect the building to the utility grid; and
a housing separate from the MSA, the housing enclosing:
a distributed energy resource (DER) disconnect switch; and
a control circuit configured to:
receive an indication, from the communication circuit, of a total current provided to the building; and
based on the indication of the total current, actuate the DER disconnect switch.

12. The MSA system of claim 11, wherein the control circuit comprises an energy management system (EMS).

13. The MSA system of claim 11, wherein the control circuit is further configured to:
based on the indication of the total current, determine an overcurrent risk; and
in response to determining the overcurrent risk, actuate the DER disconnect switch to disconnect the MSA from the DER controller; and
in response to the total current being below a predetermined threshold, actuate the DER disconnect switch to connect the MSA to the DER controller.

14. The MSA system of claim 11, wherein the communication circuit is further configured to:
measure one or more characteristics of the utility grid;
transmit the one or more characteristics of the utility grid to the DER controller, wherein the disconnect signal is received from the DER controller in response to the one or more characteristics of the utility grid.

15. The MSA system of claim 11, wherein the communication circuit is further configured to:
measure one or more characteristics of the utility grid when the whole-building disconnect switch is actuated to disconnect the building;
transmit the one or more characteristics of the utility grid to the DER controller.

16. The MSA system of claim 11, further comprising a manual connection switch for connecting or disconnecting the building from the utility grid.

17. The MSA system of claim 11, wherein the communication circuit is further configured to transmit an alert to the DER controller indicating access to the manual connection switch.

18. The MSA system of claim 11, further comprising a pluggable assembly to connect the communication circuit to the co-located electrical equipment and to provide an electrical connection between the building and the co-located electrical equipment.

19. The MSA system of claim 18, wherein the pluggable assembly includes a conversion circuit to convert analog signals from the MSA to digital signals for the co-located electrical equipment.

20. The MSA system of claim 18, wherein the pluggable assembly includes a receptacle to receive a conversion circuit to convert analog signals from the MSA to digital signals for the co-located electrical equipment.
